(19) United States
(12) Patent Application Publication
(10) Pub. No.: US 2026/0051596 A1
(43) Pub. Date: Feb. 19, 2026

(54) APPARATUS FOR ALIGNMENT OF BATTERY CELL

(71) Applicant: SK On Co., Ltd., Seoul (KR)

(72) Inventors: Sang Hee JEON, Daejeon (KR); Hyeong Uk RYU, Daejeon (KR); Seo Jeong PARK, Daejeon (KR)

(21) Appl. No.: 19/273,129

(22) Filed: Jul. 18, 2025

(30) Foreign Application Priority Data
Aug. 19, 2024 (KR) 10-2024-0110311

(51) Int. Cl. H01M 50/244; H01M 10/04

(52) U.S. Cl. CPC H01M 50/244; H01M 10/0404

(57) ABSTRACT

An apparatus for alignment of a battery cell according to an embodiment of the present disclosure may include: in order to align at least one battery cell in which an electrode assembly is accommodated inside an outer material, the outer material includes a terrace area, and at least one electrode lead is exposed to an edge of the terrace area, a first alignment portion including at least one first jig arm facing one surface of the terrace area; a second alignment portion including at least one second jig arm facing the other surface of the terrace area; and an alignment driver moving the first alignment portion and the second alignment portion in different directions to bring the first jig arm and the second jig arm into contact with the one surface and the other surface.

### CROSS-REFERENCE TO RELATED APPLICATION(S)

This patent document claims the priority and benefits of Korean Patent Application No. 10-2024-0110311 filed on Aug. 19, 2024, the disclosure of which is incorporated herein by reference in its entirety.

### TECHNICAL FIELD

The present disclosure relates to an apparatus for alignment of a battery cell.

### BACKGROUND

Batteries are widely used in small electronic devices such as mobile phones and laptop computers as well as in medium and large mechanical devices such as electric vehicles (EV), and have the advantage of being rechargeable and reusable.

An electrode assembly may be configured with an electrode plate including a cathode plate and an anode plate, and a separator separating the cathode plate and the anode plate. An electrode assembly manufactured in a stack type, a stack-folding type, a roll type, or the like, is stored in a case selected according to the intended purpose of use such as a pouch type case, a square type case, a cylindrical type case, or the like, and may be manufactured by sealing the case after injecting an electrolyte thereinto.

The battery cell manufactured in this manner may be accommodated in a tray, or the like. The tray may accommodate and support at least one battery cell, and at least one battery cell may be transferred to post-processing while being accommodated and supported in the tray.

In this case, when the electrode lead is exposed to the outside of the case, the electrode lead may be bent or warped. In this case, the quality of the battery cell may be deteriorated, and the safety the of battery cell manufacturing process may be deteriorated, such as the occurrence of a short circuit.

### SUMMARY

According to an aspect of the present disclosure, an apparatus for alignment of a battery cell capable of aligning positions of battery cells and/or electrode leads of battery cells is provided.

Additionally, the present disclosure may be widely applied to devices within green technology fields such as those of solar power generation and wind power generation.

Additionally, the present disclosure may be applied to eco-friendly devices such as eco-friendly electric vehicles and hybrid vehicles for ameliorating the effects of climate change by suppressing air pollution and greenhouse gas emissions.

An apparatus for alignment of a battery cell according to an embodiment of the present disclosure may include: in order to align at least one battery cell in which an electrode assembly is accommodated inside an outer material, the outer material includes a terrace area, and at least one electrode lead is exposed to an edge of the terrace area, a first alignment portion including at least one first jig arm facing one surface of the terrace area; a second alignment portion including at least one second jig arm facing the other surface of the terrace area; and an alignment driver moving the first alignment portion and the second alignment portion in different directions to bring the first jig arm and the second jig arm into contact with the one surface and the other surface.

In an embodiment, the first alignment portion may further include: a first alignment body extending by a predetermined length and the at least one first jig arm may extend from the first alignment body and may face the one surface, and the second alignment portion may further include: a second alignment body disposed so that at least a partial region thereof overlaps the first alignment body and the at least one second jig arm may extend from the second alignment body and may face the other surface, and the alignment driver may move the first alignment body and the second alignment body in different directions.

In an embodiment, the alignment driver may include: a first alignment driver connected to the first alignment body, and moving the first alignment body in a first direction to bring the at least one first jig arm into contact with the one surface; and a second alignment driver connected to the second alignment body, and moving the second alignment body in a second direction to bring the at least one second jig arm into contact with the other surface.

In an embodiment, the first alignment driver may move the first alignment body in the second direction to release the at least one first jig arm from contact with the one surface, and the second alignment driver may move the second alignment body in the first direction to release the at least one second jig arm from contact with the other surface.

In an embodiment, the first alignment driver and the second alignment driver may simultaneously move the first alignment body and the second alignment body.

In an embodiment, the at least one first jig arm may include: a first extension portion extending in a longitudinal direction of the battery cell from the first alignment body; and a second extension portion bent from the first extension portion and extending in a height direction of the battery cell, and contacting the one surface, and the at least one second jig arm may include: a third extension portion extending in the longitudinal direction of the battery cell from the second alignment body; and a fourth extension portion bent from the third extension portion and extending in the height direction of the battery cell, and contacting the other surface.

In an embodiment, the at least one first jig arm and the at least one second jig arm may not be in contact with the at least one electrode lead.

In an embodiment, a height of the second extension portion and a height of the fourth extension portion may be greater than or equal to a height of the electrode lead and less than or equal to a height of the battery cell.

In an embodiment, the first alignment body may include: a coupling protrusion protruding in a direction oriented toward the second alignment body, and the second alignment body may include: a coupling notch into which the coupling protrusion is inserted.

In an embodiment, the first alignment driver may include: a first driving guide member connected to the first alignment body; a first gear box connected to the first driving guide member; and a first driving motor in which a first driving shaft is connected to the first gear box, and the second alignment driver may include: a second driving guide member connected to the second alignment body; a second gear box connected to the second driving guide member; and a second drive motor in which a second drive shaft is connected to the second gearbox.

In an embodiment, the alignment driver may include: a first cylinder member connected to the first alignment body; and a second cylinder member connected to the second alignment body.

In an embodiment, the at least one first jig arm may include a first insulating member in contact with the one surface, and the at least one second jig arm may include a second insulating member in contact with the other surface.

In an embodiment, the first extension portion and the third extension portion may face each other, and at least one of the first extension portion and the third extension portion may include a protruding region protruding in a direction oriented toward at least one of the first extension portion and the third extension portion facing each other.

In an embodiment, the apparatus for alignment of a battery cell may further include: a tray supporting a plurality of battery cells so that the plurality of battery cells are spaced apart from each other by a predetermined distance; and a plurality of terrace alignment members disposed on the tray so as to be interposed between the terrace areas and spaced apart from each other by a predetermined distance from the terrace areas to form a gap, and the alignment driver may further include: a driving member moving the at least one first jig arm and the at least one second jig arm from the outside of the plurality of battery cells to the gap.

In an embodiment, the driving member may move the at least one first jig arm and the at least one second jig arm in an insertion direction, which is a height direction of the battery cell, and may move the at least one first jig arm and the at least one second jig arm into the gap.

In an embodiment, the alignment driver may bring the first jig arm and the second jig arm into contact with the one surface and the other surface after the at least one first jig arm and the at least one second jig arm are moved in the insertion direction.

According to an aspect of the present disclosure, an apparatus for alignment of a battery cell capable of aligning the positions of battery cells and/or electrode leads of battery cells may be provided.

Additionally, the present disclosure may be widely applied to devices within green technology fields such as solar power generation and wind power generation.

Additionally, the present disclosure may be applied to eco-friendly devices such as eco-friendly electric vehicles and hybrid vehicles for ameliorating the effects of climate change by suppressing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 is a schematic perspective view of an apparatus for alignment of a battery cell according to an embodiment of the present disclosure.

FIG. 2 is a schematic view of a battery cell according to an embodiment of the present disclosure, and is a front view of the battery cell.

FIG. 3 is a schematic perspective view of a portion of an apparatus for alignment of a battery cell according to another embodiment of the present disclosure.

FIG. 4 is an operating state diagram of an apparatus for alignment of a battery cell to another embodiment of the present disclosure.

FIG. 5 is a schematic perspective view of a portion of an apparatus for alignment of a battery cell according to another embodiment of the present disclosure.

FIG. 6 is an operating state diagram of an apparatus for alignment of a battery cell according to another embodiment of the present disclosure.

FIG. 7 is a schematic front view of a state in which a first terrace area is pressurized by a first jig arm and a second jig arm according to an embodiment of the present disclosure.

FIG. 8 is a schematic front view of a state in which a second terrace area is pressurized by another first jig arm and another second jig arm according to an embodiment of the present disclosure.

FIG. 9 is a partial perspective view of an apparatus for alignment of a battery cell according to another embodiment of the present disclosure.

FIG. 10 is a partial perspective view of an apparatus for alignment of a battery cell according to another embodiment of the present disclosure.

FIG. 11 is a plan view schematically illustrating a portion of an apparatus for alignment of a battery cell according to another embodiment of the present disclosure.

FIG. 12 is a plan view schematically illustrating a state in which a first terrace area is pressurized by a first jig arm and a second jig arm according to an embodiment of the present disclosure.

FIG. 13 is a plan view schematically illustrating a state in which a first terrace area is pressurized by a first jig arm and a second jig arm according to another embodiment of the present disclosure.

FIG. 14 is a front view schematically illustrating a state in which a driving member of an apparatus for alignment of a battery cell according to another embodiment of the present disclosure moves the first jig arm and the second jig arm.

FIG. 15 is a front view schematically illustrating a state in which a driving member of an apparatus for alignment of a battery cell according to another embodiment of the present disclosure moves a first jig arm and a second jig arm.

### DETAILED DESCRIPTION

In order to help understand the description of the embodiment of the present disclosure, elements described with the same symbol in the accompanying drawings are the same elements. Some components in the attached drawings are exaggerated, omitted, or schematically illustrated, and the size of each component does not completely reflect the actual size.

Additionally, in order to clarify the gist of the present disclosure, descriptions of elements and techniques well known by the prior art are omitted, and the present disclosure will be described in detail below with reference to the accompanying drawings.

Hereinafter, an X-axis illustrated in the drawings is a thickness direction of the battery cell, a Y-axis is a longitudinal direction or a width direction of the battery cell, and a Z-axis is a height direction of the battery cell. However, these are directions arbitrarily set for the convenience of understanding, and the directions may be changed.

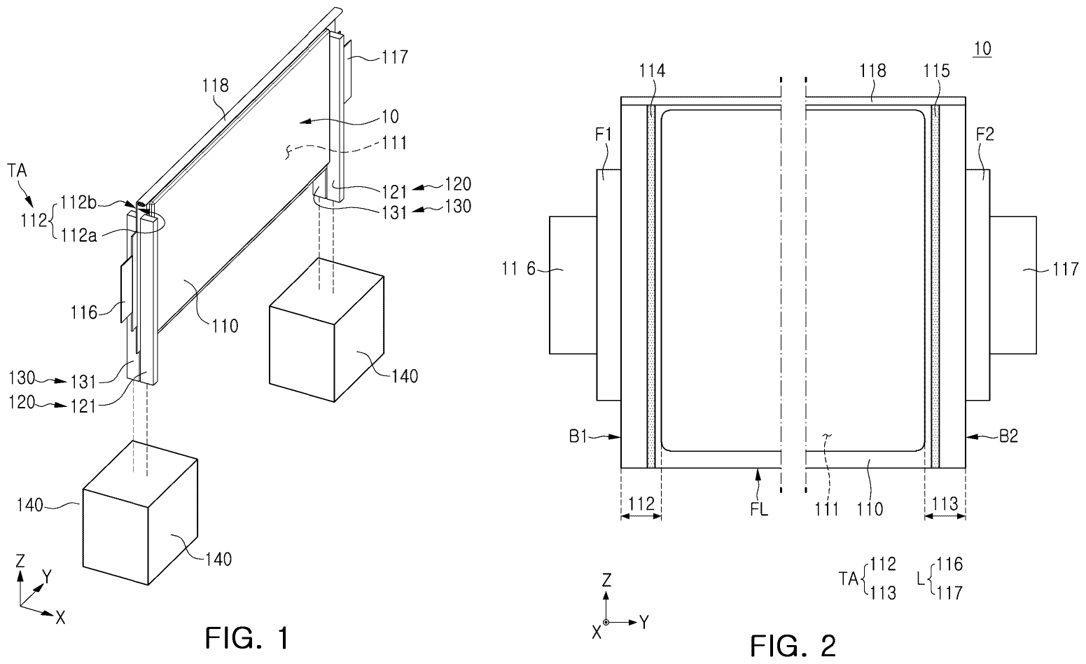

FIG. 1 is a schematic perspective view of an apparatus for alignment of a battery cell according to an embodiment of the present disclosure, and FIG. 2 is a schematic illustration of a battery cell 10 according to an embodiment of the present disclosure, and is a front view of the battery cell 10.

First, FIG. 1 illustrates a case in which an apparatus for alignment of a battery cell aligns a terrace area TA of one battery cell 10, and the battery cell 10 is a bidirectional battery cell 10. In the bidirectional battery cell 10, a first electrode lead 116 and a second electrode lead 117 may be drawn out to one side and the other side of an outer material 110, respectively.

As illustrated in FIG. 1 and FIG. 2, a first jig arm 121 of a first alignment portion 120 may face one surface 112a of a first terrace area 112 adjacent to the first electrode lead 116, and a second jig arm 131 of a second alignment portion 130 may face the other surface 112b of the first terrace area 112.

The first jig arm 121 and the second jig arm 131 may pressurize the first terrace area 112 by moving in different directions. For example, the first jig arm 121 may be moved in an −X-direction, and the second jig arm 131 may be moved in a +X-direction to pressurize the first terrace area 112. Another terrace area TA adjacent to the second electrode lead 117, that is, the second terrace area 113 (see FIG. 2), may also be pressurized by another first jig arm 121 and another second jig arm 131 using the same principle as above.

The first jig arm 121 and the second jig arm 131 may be moved in different directions by an alignment driver 140. The alignment driver 140 may be provided in plural. One alignment driver 140 may move the first jig arm 121 and the second jig arm 131 pressurizing the first terrace area 112, and another alignment driver 140 may move the first jig arm 121 and the second jig arm 131 pressurizing the second terrace area 113 (see FIG. 2).

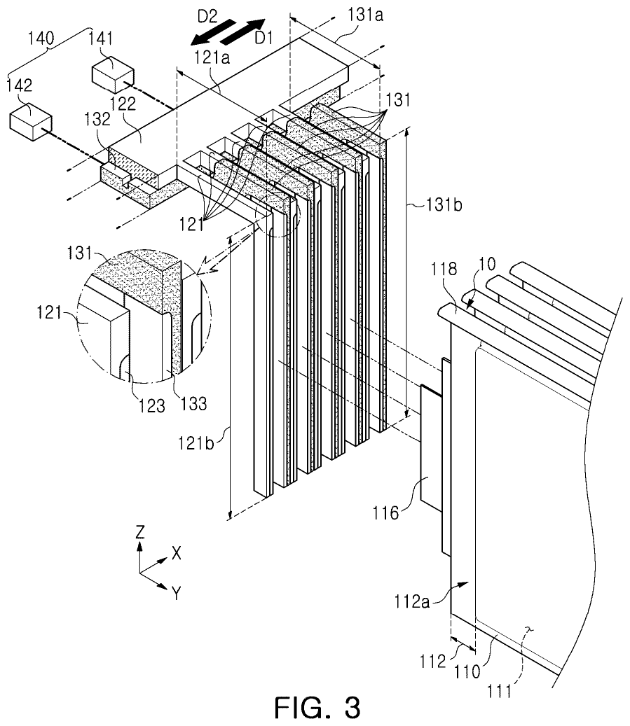

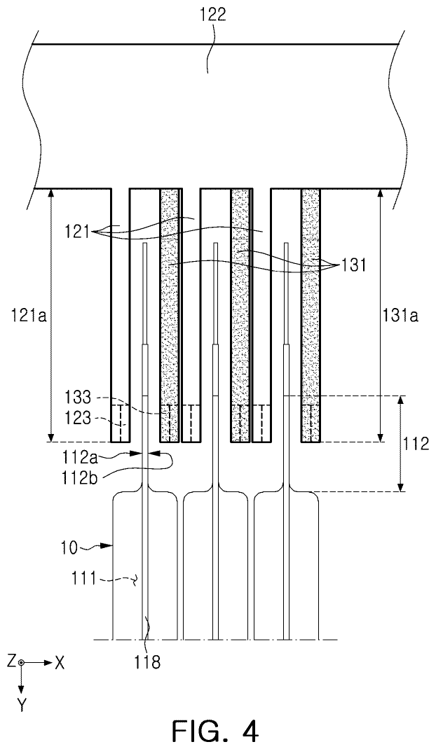

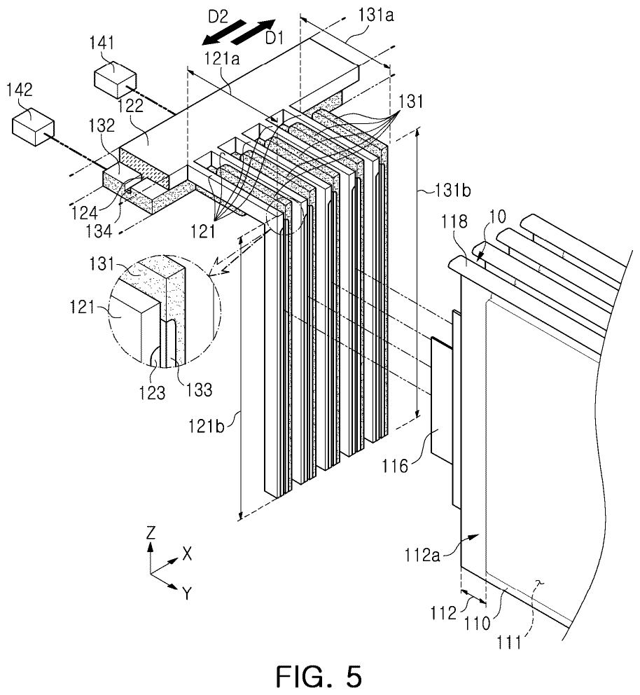

Meanwhile, FIG. 3 is a perspective view schematically illustrating a portion of an apparatus for alignment of a battery cell according to another embodiment of the present disclosure, and FIG. 4 is an operating state diagram of an apparatus for alignment of a battery cell according to another embodiment of the present disclosure, and is illustrated from the perspective of the plan view of FIG. 3. As illustrated in FIGS. 2 to 4, an apparatus for alignment of a battery cell according to another embodiment of the present disclosure may include: to order to align at least one battery cell 10 in which an electrode assembly is accommodated inside an outer material 110, the outer material 110 includes a terrace area TA and at least one electrode lead L is exposed to an edge of the terrace area TA, a first alignment portion 120 including at least one first jig arm 121 facing one surface of the terrace area TA, a second alignment portion 130 including at least one second jig arm 131 facing the other surface of the terrace area TA, and an alignment driver 140 moving the first alignment portion 120 and the second alignment portion 130 in different directions to bring the first jig arm 121 and the second jig arm 131 into contact with the one surface and the other surface.

At least one battery cell 10 may include a plurality of battery cells 10. The plurality of battery cells 10 may be arranged in a direction, parallel to at least one of the X-axis, the Y-axis and the Z-axis. For example, the plurality of battery cells 10 may be arranged or stacked in a direction, parallel to the X-axis. The plurality of battery cells 10 may be arranged or stacked so that surfaces having a larger area, among the plurality of surfaces forming the outer material 110, face each other.

When a plurality of battery cells 10 are provided, a first jig arm 121 and a second jig arm 131 may be disposed in a space formed by a pair of battery cells 10 facing each other, that is, a space between a terrace area TA of one battery cell 10 and a terrace area TA of another battery cell 10 adjacent to the one battery cell 10. In this case, the first jig arm 121 may face one surface 112a of the first terrace area 112 of the another battery cell 10, and the second jig arm 131 may face the other surface 112b of the first terrace area 112 of one of the battery cells 10.

In an embodiment, the terrace area TA may be provided in the outer material 110 and may include a first terrace area 112 and a second terrace area 113. One surface of the terrace area TA may include one surface 112a of the first terrace area 112 and one surface (113a of FIG. 13) of the second terrace area 113, and the other surface of the terrace area TA may include the other surface 112b of the first terrace area 112 and the other surface of the second terrace area 113.

In an embodiment, the outer material 110 of the battery cell 10 may be a film including aluminum. The battery cell 10 may be a pouch-type battery cell 10.

The battery cell 10 may have at least one electrode assembly accommodated in the outer material 110. The at least one electrode assembly may include a plurality of electrode assemblies. The electrode assembly may include an anode plate, a cathode plate, and a separator.

At least one electrode lead L may include a first electrode lead 116 and a second electrode lead 117. In an embodiment, in the battery cell 10, the first electrode lead 116 electrically connected to the anode plate may be drawn out from a first edge B1 of the outer material 110 in a −Y-direction, and a second electrode lead 117 electrically connected to the cathode plate may be drawn out from a second edge B2 of the outer material 110 in a +Y-direction. Such a battery cell 10 may be a bidirectional battery cell 10.

Hereinafter, as described above, a case in which the pouch-type battery cell 10 is a bidirectional battery cell 10 will be described as an example. However, the type of the battery cell 10 is not necessarily limited by the present disclosure, and as the battery cell 10, a unidirectional battery cell 10 in which the first electrode lead 116 and the second electrode lead 117 are exposed to the same edge of the outer material 110, for example, the first edge B1 or the second edge B2, may be applied. An outer line of the outer material may include the first edge B1 and the second edge B2.

As illustrated in FIG. 2, the battery cell 10 may have a structure in which the outer material 110 is folded along a folding line FL so that ends of both sides of the outer material 110 are in contact with each other, and the remaining three edges of the outer material 110 except for the folding line FL overlap each other and the overlapped area is heat-welded and then sealed.

In the sealed outer material 110, at least a partial region of the first electrode lead 116 and at least a partial region of the second electrode lead 117 may be exposed to the outside of the outer material 110. A side sealing portion 118 disposed parallel to a width direction (e.g., Y-axis direction) of the battery cell 10 in the outer material 110 may be rolled or folded and fixed to an outer surface of the outer material 110.

At least one terrace area TA may be provided on the outer surface of the outer material 110. The terrace area TA may be formed on the outer surface of the outer material 110. When viewing the outer material 110 from the front, the terrace area TA may be an area in which the electrode assembly is accommodated in the outer material 110 and the remaining area excluding the side sealing portion 118.

As illustrated in FIG. 2, the terrace area TA may not face an electrode assembly and/or an electrode assembly accommodation space 111 accommodated inside the outer material 110 in the X-axis direction and may not overlap with the electrode assembly and/or the electrode assembly accommodation space 111 in the X-axis direction. At least one electrode assembly may be accommodated together with an electrolyte in the electrode assembly accommodation space 111 of the outer material 110.

The terrace area TA may be exposed to the outer surface of the outer material 110. The terrace area TA may include a first lead sealing portion 114 and a second lead sealing portion 115, which are areas in which the outer material 110 is sealed. In this case, the side sealing portion 118 may be excluded from the terrace area TA.

At least one terrace area TA may include a first terrace area 112 and a second terrace area 113. The first terrace area 112 may be adjacent to the electrode assembly accommodation space 111 in the −Y-direction.

The first lead sealing portion 114, which is an area in which the outer material 110 is sealed, at least a partial region of the first electrode lead 116, and at least a partial region of a first lead film F1 may be disposed on an inner surface of the first terrace area 112. The first lead film F1 may include a material having electrical insulation properties, and may perform electrical insulation between the first electrode lead 116 and the outer material 110 in a position adjacent to the first lead sealing portion 114.

The second terrace area 113 may be adjacent to the electrode assembly accommodation space 111 in the +Y-direction. The first terrace area 112 and the second terrace area 113 may be spaced apart from each other with the electrode assembly accommodation space 111 interposed therebetween.

The second lead sealing portion 115, which is a region in which the outer material 110 is sealed, at least a partial region of the second electrode lead 117, and at least a partial region of a second lead film F2 may be disposed on an inner surface of the second terrace area 113. The second lead film F2 may include a material having electrical insulation, and may perform electrical insulation between the second electrode lead 117 and the outer material 110 in a position adjacent to the second lead sealing portion 115.

The first terrace area 112 and the second terrace area 113 may be provided on one surface of the outer material 110 and the other surface of the outer material 110. An area illustrated in FIG. 2 may be one side of the outer material 110, and the other side of the outer material 110 may be disposed behind or below (or at the rear) in the −X-direction with respect to the one surface of the outer material 110 illustrated in FIG. 2. In this case, the one surface of the outer material 110 may include one surface 112a of the first terrace area 112 and one surface (113a of FIG. 13) of the second terrace area 113, and the other surface of the outer material 110 may include the other surface 112b of the first terrace area 112 and the other surface of the second terrace area 113.

In an embodiment, the apparatus for alignment of a battery cell may be provided in each of the first terrace area 112 and the second terrace area 113.

The apparatus for alignment of a battery cell disposed in the first terrace area 112 may have at least one first jig arm 121 facing one surface 112a of the first terrace area 112, and may have at least one second jig arm 131 facing the other surface 112b of the first terrace area 112.

One surface (113a of FIG. 13) of the second terrace area 113 may be disposed on the same surface as one surface 112a of the first terrace area 112 in the outer material 110, and the other side of the second terrace area 113 may also be disposed on the same surface as the other surface 112b of the first terrace area 112 in the outer material 110.

The apparatus for alignment of a battery cell disposed in the second terrace area 113 may have at least one first jig arm 121 facing one surface (113a of FIG. 13) of the second terrace area 113, and may have at least one second jig arm 131 facing the other surface of the second terrace area 113.

In this case, the first jig arm 121 of the apparatus for alignment of a battery cell disposed in the first terrace area 112 and the first jig arm 121 of the apparatus for alignment of a battery cell disposed in the second terrace area 113 may face one surface 112a of the first terrace area 112 of one battery cell 10 and one surface (113a of FIG. 13) of the second terrace area 113 of one battery cell 10, respectively.

Additionally, the second jig arm 131 of the apparatus for alignment of a battery cell disposed in the first terrace area 112 and the second jig arm 131 of the apparatus for alignment of a battery cell disposed in the second terrace area 113 may face the other surface 112b of the first terrace area 112 of the one battery cell 10 and the other surface of the second terrace area 113 of the one battery cell 10, respectively.

Accordingly, one surface 112a of the first terrace area 112 may be disposed on the same plane as one surface (113a of FIG. 13) of the second terrace area 113, and the other surface 112b of the first terrace area 112 may be located on the same plane as the other surface of the second terrace area 113.

For example, with respect to one surface 112a of the first terrace area 112 and one surface (113a of FIG. 13) of the second terrace area 113, the other surface 112b of the first terrace area 112 and the other surface of the second terrace area 113 may be respectively disposed behind or below (or at the rear) in the −X-direction. The above-described content relates to a bidirectional battery cell 10, and in the case of the bidirectional battery cell 10, the apparatus for alignment of a battery cell may be provided to face the first terrace area 112 and the second terrace area 113 of the battery cell 10, respectively.

On the other hand, in the case of a unidirectional battery cell 10, one apparatus for alignment of battery cell may be provided to face the first terrace area 112 and the second terrace area 113 of the battery cell 10. On the other hand, in the case of the bidirectional battery cell 10, at least two apparatuses for alignment of a battery cell may be provided to face the first terrace area 112 and the second terrace area 113, respectively.

Hereinafter, a case in which a plurality of apparatuses for alignment of a battery cell are provided and the plurality of apparatuses for alignment of a battery cell are provided to face the first terrace area 112 and the second terrace area 113 of the battery cell 10, respectively, will be described as an example.

The first terrace area 112 may be disposed around the first electrode lead 116, and one surface of the first terrace area 112 may be parallel to a Y-Z plane. The other surface 112b of the first terrace area 112 may oppose one surface 112a of the first terrace area 112, and may be parallel to the Y-Z plane.

In FIG. 2, one surface 112a of the first terrace area 112 is illustrated, and the other surface 112b of the first terrace area 112 may oppose the one surface 112a of the first terrace area 112 in the X-axis direction. The other surface 112b of the first terrace area 112 may be disposed behind or below (or at the rear) the one surface 112a of the first terrace area 112 in the −X-direction.

In the Y-Z plane, the one surface 112a of the first terrace area 112 and the other surface 112b of the first terrace area 112 may overlap each other.

The second terrace area 113 may be disposed around the second electrode lead 117, and the one surface of the second terrace area 113 may be parallel to the Y-Z plane. The other surface of the second terrace area 113 may oppose one surface of the second terrace area 113 and may be parallel to the Y-Z plane.

In FIG. 2, one surface of the second terrace area 113 is illustrated, and the other surface of the second terrace area 113 may oppose one surface of the second terrace area 113 in the X-axis direction. The other surface of the second terrace area 113 may be disposed behind or below (or at the rear) one surface of the second terrace area 113 in the −X-direction. The other surface of the second terrace area 113 may be a rear surface of the outer material 110 in the −X-direction.

In the Y-Z plane, one surface of the second terrace area 113 and the other surface of the second terrace area 113 may overlap each other.

One surface 112a of the first terrace area 112 and one surface (113a in FIG. 13) of the second terrace area 113 may be disposed on the same plane, and the other surface 112b of the first terrace area 112 and the other surface of the second terrace area 113 may be disposed on the same plane.

One surface 112a of the first terrace area 112, one side (113a in FIG. 13) of the second terrace area 113, the other surface 112b of the first terrace area 112 and the other side of the second terrace area 113 may be included in one battery cell 10 or one outer material 110.

Meanwhile, as illustrated in FIG. 1, when a plurality of battery cells 10 are provided and the plurality of battery cells 10 are arranged in the X-axis direction, the other surface 112b of the first terrace area 112 may oppose one surface 112a of the first terrace area 112 of another battery cell 10 adjacent to the battery cell 10 in the −X-direction.

Additionally, as illustrated in FIG. 1 and FIG. 2, the other surface of the second terrace area 113 may also face one surface (113a of FIG. 13) of the second terrace area 113 of another battery cell 10 adjacent to the battery cell 10 in the −X-direction.

In order to align a plurality of battery cells 10, at least one first jig arm 121 may include a plurality of first jig arms 121, and at least one second jig arm 131 may also include a plurality of second jig arms 131. In this case, the alignment driver 140 may also include a plurality of alignment drivers 140.

The first terrace area 112 may be interposed between the first jig arm 121 and the second jig arm 131. A plurality of first jig arms 121 and a plurality of second jig arms 131 may be alternately disposed in the X-axis direction.

The first terrace area 112 will be described below, and in the first terrace area 112, the first jig arm 121 may face one surface 112a of the first terrace area 112, and the second jig arm 131 may face the other surface 112b of the first terrace area 112.

The alignment driver 140 may move the first jig arm 121 and the second jig arm 131, and the first jig arm 121 and the second jig arm 131 may be moved in a direction oriented toward each other or in a direction oriented toward the first terrace area 112 by the alignment driver 140, thus pressurizing the one surface 112a and the other surface 112b of the first terrace area 112.

Additionally, the alignment driver 140 may move the first jig arm 121 and the second jig arm 131 in a direction in which the first jig arm 121 and the second jig arm 131 are away from each other, and the first jig arm 121 and the second jig arm 131 may be released from contact with one surface 112a and the other surface 112b of the first terrace area 112. Accordingly, the first jig arm 121 and the second jig arm 131 may release the pressure applied onto one surface 112a and the other surface 112b of the first terrace area 112.

The above-described content may be applied to the second terrace area 113 in the same principle. In the second terrace area 113, the first jig arm 121 of another battery cell alignment device may face one surface (113a of FIG. 13) of the second terrace area 113, and the second jig arm 131 may face the other surface of the second terrace area 113.

Another alignment driver 140 may move the first jig arm 121 and the second jig arm 131, and the first jig arm 121 and the second jig arm 131 may be moved in a direction in which the first jig arm 121 and the second jig arm 131 are moved closer to each other or in a direction oriented toward the second terrace area 113 by the alignment driver 140, thereby pressurizing the one surface (113a of FIG. 13) and the other surface 113b of the second terrace area 113.

Additionally, the alignment driver 140 may move the first jig arm 121 and the second jig arm 131 in a direction in which the first jig arm 121 and the second jig arm 131 are away from each other, and the first jig arm 121 and the second jig arm 131 may be released from contact with one surface (113a of FIG. 13) and the other surface of the second terrace area 113. Accordingly, the first jig arm 121 and the second jig arm 131 may release pressure applied onto one surface (113a of FIG. 13) and the other surface of the second terrace area 113.

With the principle described above, at least one of the first terrace area 112 and the second terrace area 113 of the plurality of battery cells 10 may be pressurized by the first jig arm 121 and the second jig arm 131.

The battery cell 10 in which the first terrace area 112 and the second terrace area 113 are pressurized may complete positional alignments of the first electrode lead 116 and the second electrode lead 117, and the first electrode lead 116 and the second electrode lead 117 may have at least a straight line shape. The first electrode lead 116 and the second electrode lead 117 in which the positional alignments are completed may be parallel to the Y-axis or the side sealing portion 118 in the X-Y plane.

In a state before pressurizing the first terrace area 112, the first jig arm 121 and the second jig arm 131 may be spaced apart from each other by the same distance in the first terrace area 112. Additionally, the alignment driver 140 may move the first jig arm 121 and the second jig arm 131 by the same distance in the −X-direction and the +X-direction, respectively. Accordingly, the first jig arm 121 and the second jig arm 131 may maintain the balance of the force for pressurizing the battery cell 10. Accordingly, the first electrode lead 116 and the second electrode lead 117 may be prevented from being deflected in either direction.

As described above, the first jig arm 121 and the second jig arm 131 may be moved by the alignment driver 140 to perform a contact operation and a pressurization operation, and the first jig arm 121 and the second jig arm 131 may be moved by the alignment driver 140 to perform a contact release operation and a pressurization release operation.

According to the present disclosure, the first terrace area 112 and the second terrace area 113 may be disposed to be parallel to the side sealing portion 118, may be disposed to be parallel to the Y-axis in the X-Y plane, and may be prevented from being deflected in either direction.

Additionally, according to the present disclosure, positions of the first terrace area 112 and the second terrace area 113 may be aligned to given positions.

Additionally, the battery cells 10 may be aligned so that a gap between the plurality of first electrode leads 116 in the X-axis direction is constant, and the battery cells 10 may be aligned so that a gap between the plurality of second electrode leads 117 in the X-axis direction is constant.

Meanwhile, the first electrode leads 116 and the second electrode leads 117 may include a material having electrical conductivity, such as aluminum or copper. A material of the first electrode lead 116 and the second electrode lead 117 may be appropriately selected and applied according to the electrical polarity of the electrode plate to which the first electrode lead 116 and the second electrode lead 117 are connected.

The first electrode lead 116 and the second electrode lead 117 may be relatively thin and may be supported by the first terrace area 112 and the second terrace area 113, respectively.

Accordingly, in the present disclosure, the positions of the first electrode lead 116 and the second electrode lead 117 may be aligned by pressurizing the first terrace area 112 and the second terrace area 113 and depressurizing the first electrode lead 116 and the second electrode lead 117.

According thereto, deformation of the relatively thin first electrode lead 116 and second electrode lead 117 may be prevented, and at the same time, the battery cell 10 may be aligned. Additionally, according to the present disclosure, deformation such as bending or bending of the first electrode lead 116 and the second electrode lead 117 may be prevented. Additionally, according to the present disclosure, damage such as scratches or dents may be prevented from occurring in the outer material 110 by the first electrode lead 116 and the second electrode lead 117, and short circuiting of the battery cell 10 may be prevented.

FIG. 3 is a perspective view schematically illustrating a portion of an apparatus for alignment of a battery cell according to an embodiment of the present disclosure, and illustrates a portion of the first alignment body 122 and the second alignment body 132 in cross-section. FIG. 4 is an operating state diagram of an apparatus for alignment of a battery cell according to an embodiment of the present disclosure, and is illustrated from a plan viewpoint. FIG. 3 and FIG. 4 illustrate a state before an apparatus for alignment of a battery cell according to an embodiment of the present disclosure pressurizes a first terrace area 112.

As illustrated in FIG. 3 and FIG. 4, in an embodiment of the present disclosure, the first alignment portion 120 may further include a first alignment body 122 extending by a predetermined length, and at least one first jig arm 121 may extend from the first alignment body 122 and may face the one surface 112a. In this case, the one surface 112a may be one surface 112a of the first terrace area 112.

Additionally, the second alignment portion 130 may further include a second alignment body 132 disposed so that at least a partial region thereof overlaps the first alignment body 122, and the at least one second jig arm 131 may extend from the second alignment body 132 and may face the other surface 112b. In this case, the other surface 112b may be the other surface 112b of the first terrace area 112.

In an embodiment, the alignment driver 140 may move the first alignment body 122 and the second alignment body 132 simultaneously. Accordingly, a plurality of first jig arms 121 may be moved simply by moving the first alignment body 122, and a plurality of second jig arms 131 may be moved simply by moving the second alignment body 132.

Additionally, by moving the first alignment body 122 and the second alignment body 132 simultaneously, one surface 112a and the other surface (112b in FIG. 1) of the first terrace area 112 may be pressurized with uniform force. Therefore, the first terrace area 112 may be prevented from being deformed in one direction.

The alignment driver 140 may move the first alignment body 122 and the second alignment body 132 in different directions. In an embodiment, the alignment driver 140 may include a first alignment driver 141 moving the first alignment body 122 in a first direction D1 and a second alignment driver 142 moving the second alignment body 132 in a second direction D2.

The first alignment driver 141 and the second alignment driver 142 may move the first alignment body 122 and the second alignment body 132 in different directions or opposite directions in a state in which the first alignment body 122 and the second alignment body 132 overlap each other.

For example, the alignment driver 140 may move the first alignment body 122 in the +X-direction (e.g., first direction, D1) to pressurize the first terrace area 112, and may move the second alignment body 132 in the −X-direction (e.g., second direction, D2). The alignment driver 140 may move the first alignment body 122 in the −X-direction to depressurize the first terrace area 112, and may move the second alignment body 132 in the +X-direction.

In an embodiment, when a plurality of battery cells 10 are provided, the plurality of battery cells 10 may be spaced apart from each other by a certain distance.

In this case, the first alignment body 122 and the second alignment body 132 may extend in a direction in which the plurality of battery cells 10 are arranged.

At least one first jig arm 121 may include a plurality of first jig arms 121, and at least one second jig arm 131 may include a plurality of second jig arms 131. The plurality of first jig arms 121 may be provided to be spaced apart from each other in the X-axis direction in the first alignment body 122.

The plurality of second jig arms 131 may also be provided to be spaced apart from each other in the X-axis direction in the second alignment body 132.

The first alignment body 122 and the second alignment body 132 may be in contact with each other and may overlap each other in the Z-axis direction in the X-Y plane. In an embodiment, the second alignment body 132 may be disposed below (in a lower portion) the first alignment body 122 in the −Z-direction. The first alignment body 122 and the second alignment body 132 may be provided to slide while in contact with each other.

In an embodiment, the first alignment body 122 may include a coupling protrusion (124 of FIG. 5) protruding from a bottom surface in the −Z-direction in a direction oriented toward the second alignment body 132. Additionally, the second alignment body 132 may include a coupling notch (134 of FIG. 5) formed on an upper surface in the +Z-direction. The coupling protrusion (124 of FIG. 5) may be inserted into the coupling notch (134 of FIG. 5), and according to the coupling notch (134 of FIG. 5) and the coupling protrusion (124 of FIG. 5), the coupling between the first alignment body 122 and the second alignment body 132 may be firmly maintained.

Additionally, according to the coupling notch (134 of FIG. 5) and the coupling protrusion (124 of FIG. 5), a sliding path of the first alignment body 122 and the second alignment body 132 may be set in advance. Additionally, when the first alignment body 122 and the second alignment body 132 slide, the first alignment body 122 and the second alignment body 132 may be prevented from misalignment or disengaging from each other.

In a state where the first alignment body 122 and the second alignment body 132 are coupled to each other, the second jig arm 131 may be disposed between a pair of first jig arms 121. Additionally, the first jig arm 121 may be disposed between a pair of second jig arms 131.

The first jig arm 121 and the second jig arm 131 may be disposed alternately in the X-axis direction. The first terrace area 112 may be disposed between the first jig arm 121 and the second jig arm 131. When the apparatus for alignment of a battery cell is also provided in the second terrace area 113, the second terrace area 113 may be disposed between the first jig arm 121 and the second jig arm 131.

In an embodiment, the plurality of first jig arms 121 may include a first extension portion 121a extending in a longitudinal direction of the battery cell 10 from the first alignment body 122 and a second extension portion 121b bent from the first extension portion 121a and extending in a height direction of the battery cell 10, and contacting one surface 112a of the first terrace area 112.

Additionally, the plurality of second jig arms 131 may include a third extension portion 131a extending in the longitudinal direction of the battery cell 10 from the second alignment body 132, and a fourth extension portion 131b bent from the third extension portion 131a and extending in the height direction of the battery cell 10, and contacting the other surface 112b of the first terrace area 112.

The first extension portion 121a and the third extension portion 131a may extend in a direction parallel to the Y-axis, and the first extension portion 121a and the third extension portion 131a may be parallel to each other. Additionally, the first extension portion 121a and the third extension portion 131a may face each other, and the second extension portion 121b and the fourth extension portion 131b may also face each other.

In an embodiment, the second extension portion 121b may extend by being bent in the −Z-direction from the first extension portion 121a, and the fourth extension portion 131b may extend by being bent in the −Z-direction from the third extension portion 131a. The second extension portion 121b and the fourth extension portion 131b may be parallel to each other.

In this case, the first terrace area 112 may be interposed between the second extension portion 121b and the fourth extension portion 131b. An end of the first electrode lead 116 may not be in contact with the second extension portion 121b and the fourth extension portion 131b. In this manner, in an embodiment of the present disclosure, the plurality of first jig arms 121 and the plurality of second jig arms 131 may not be in contact with the electrode lead (L in FIG. 2).

For example, the first extension portion 121a, the second extension portion 121b, the third extension portion 131a and the fourth extension portion 131b may not be in contact with the first electrode lead 116. Additionally, the end of the first electrode lead 116 may not be in contact with the second extension portion 121b and the fourth extension portion 131b.

According to the first jig arm 121 and the second jig arm 131 as described above, the shapes of the first jig arm 121 and the second jig arm 131 optimized for pressurizing the first terrace area 112 of the battery cell 10 may be implemented.

The first extension portion 121a and the third extension portion 131a may not be in contact with the first terrace area 112, and the second extension portion 121b and the fourth extension portion 131b may be in contact with the first terrace area 112. Accordingly, the first jig arm 121 and the second jig arm 131 may be prevented from contacting the first electrode lead 116. This may be equally applied to the second terrace area 113 and the second electrode lead 117.

Accordingly, the present disclosure may align positions of the first terrace area 112 and the first electrode lead 116 by pressurizing only the first terrace area 112 while preventing damage and deformation of the first electrode lead 116.

Additionally, simply by bringing the second extension portion 121b and the fourth extension portion 131b into contact with the first terrace area 112, a separation gap in the X-axis-direction between the first terrace areas 112 of the plurality of battery cells 10 may be aligned evenly.

That is, simply by bringing the first jig arm 121 and the second jig arm 131 into contact with the first terrace area 112, a separation gap in X-axis-direction between the plurality of first terrace areas 112 may be aligned to be equal to or greater than a thickness of the first jig arm 121 and the second jig arm 131 in X-axis-direction.

In an embodiment, at least one first jig arm 121 may include a first insulating member 123 in contact with one surface 112a of the first terrace area 112, and at least one second jig arm 131 may include a second insulating member 133 in contact with the other surface 112b of the first terrace area 112.

The first insulating member 123 and the second insulating member 133 may include a material having electrical insulation properties and may be in contact with the outer material 110.

Accordingly, damage and deformation of the outer material 110 may be prevented, and the battery cell 10 may be aligned while ensuring electrical safety of the battery cell 10. The material of the first insulating member 123 and the second insulating member 133 is not necessarily limited by the present disclosure.

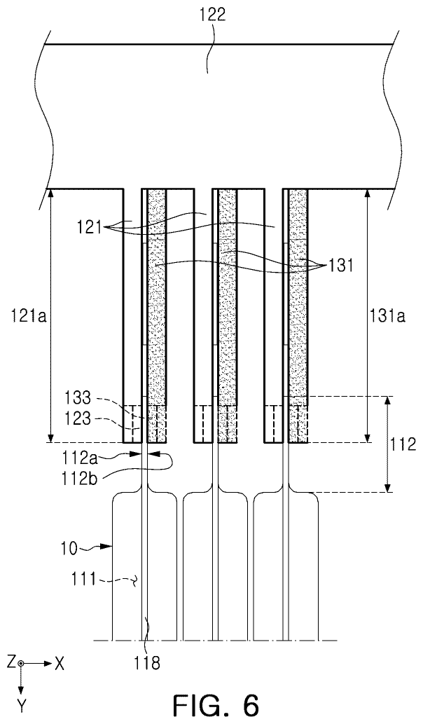

FIG. 5 is a perspective view schematically illustrating a portion of an apparatus for alignment of a battery cell according to another embodiment of the present disclosure, and illustrates a portion of the first alignment body 122 and the second alignment body 132 in cross-section. FIG. 6 is an operation state diagram of an apparatus for alignment of a battery cell according to another embodiment of the present disclosure, and is illustrated from a plan viewpoint. FIGS. 5 and 6 illustrate a state in which the apparatus for alignment of a battery cell according to another embodiment of the present disclosure pressurizes the first terrace area 112. FIGS. 5 and 6 illustrate a state in which the first jig arm 121 and the second jig arm 131 are in contact with the first terrace area 112, and a state in which the first terrace area 112 is pressurized by the first jig arm 121 and the second jig arm 131.

As illustrated in FIGS. 5 and 6, in order to pressurize the first terrace area 112, the first alignment body 122 may be moved in the +X-direction, and the second alignment body 132 may be moved in the −X-direction. Conversely, in order to depressurize the first terrace area 112, the first alignment body 122 may be moved in the −X-direction, and the second alignment body 132 may be moved in the +X-direction. The movement of the first alignment body 122 and the second alignment body 132 may be performed by the alignment driver 140.

In an embodiment, at least one of the alignment driver 140, the first alignment body 122 or the second alignment body 132 may be provided with a linear motion structure. The linear motion structure may include at least one of linear bearings, linear guides, ball screws, linear actuators, linear motors, or linear slides.

Additionally, the linear motion structure may be formed with a combination of a plurality of these. Accordingly, the reliability, precision, and accuracy of the operation in which the alignment driver 140 moves the first alignment body 122 and the second alignment body 132 may be improved.

In an embodiment, the first terrace area 112 may be interposed between the second extension portion 121b and the fourth extension portion 131b. In a state in which the first terrace area 112 is pressurized by the second extension portion 121b and the fourth extension portion 131b, an end of the first electrode lead 116 in the −Y-direction may not be in contact with the second extension portion 121b and the fourth extension portion 131b. This may be applied to the second terrace area 113, and another second extension portion 121b and the fourth extension portion 131b pressurizing the second terrace area 113 using the same principle. An end of the second electrode lead 117 may be non-pressurized by the first jig arm 121 and the second jig arm 131.

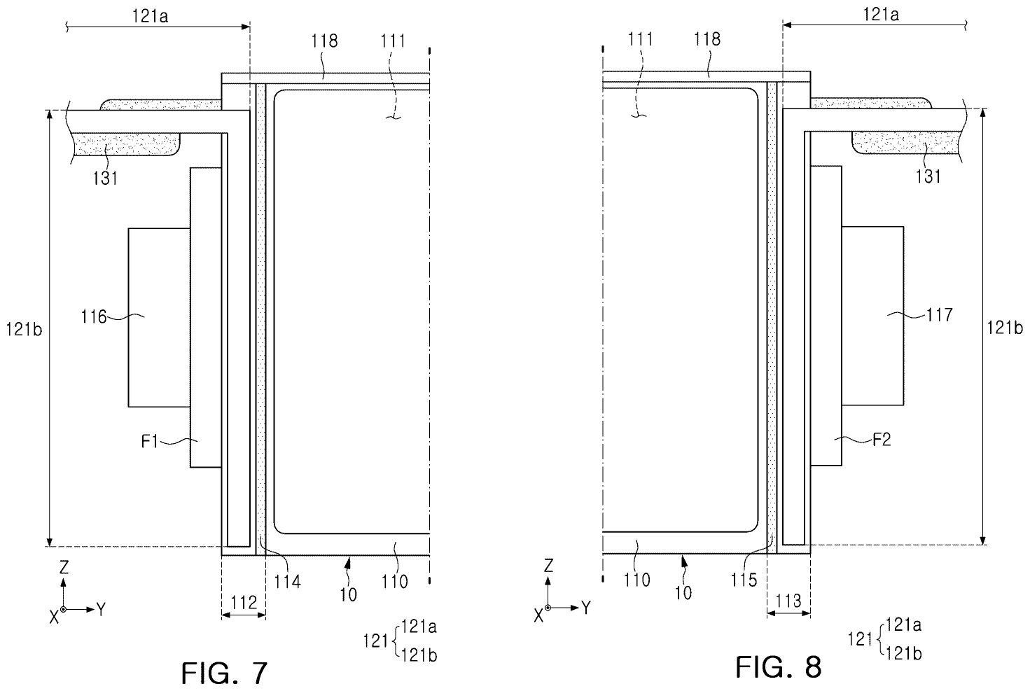

FIG. 7 schematically illustrates a state in which a first terrace area 112 is pressurized by a first jig arm 121 and a second jig arm 131 according to an embodiment of the present disclosure, and is illustrated from a front view.

As illustrated in FIG. 7, the first electrode lead 116 and the first lead film F1 in the first terrace area 112 may be unpressurized by the first jig arm 121 and the second jig arm 131. The first electrode lead 116 and the first lead film F1 may not be in contact with the first jig arm 121 and the second jig arm 131.

In an embodiment, the second extension portion 121b and the fourth extension portion (131b of FIG. 9) may pressurize a region of the first terrace area 112 excluding the first lead sealing portion 114. The first lead sealing portion 114 may be a region included in the first terrace area 112.

The first lead sealing portion 114 may be formed in a direction, intersecting the side sealing portion 118. The first lead sealing portion 114 may be a region heat-welded in the outer material 110. The first lead sealing portion 114 may be disposed adjacently to the first electrode lead 116. The first lead sealing portion 114 may be formed parallel to the Z-axis.

The second extension portion 121b and the fourth extension portion (131b of FIG. 9) may pressurize a region between an edge of the outer material 110 in the −Y-direction and an edge of the first lead sealing portion 114 in the first terrace area 112.

Accordingly, it may be possible to prevent the sealing quality of the battery cell 10 from being deteriorated, and the battery cell 10 may align the position of the battery cell 10 and the position of the first electrode lead 116 without quality deterioration.

In an embodiment, the first electrode lead 116 of the battery cell 10 may be in contact with the anode plate accommodated in the electrode assembly accommodation space 111. For example, an inner surface of a region corresponding to the first terrace area 112 in the outer material 110 may face a connection region between the first electrode lead 116 and the anode plate.

That is, the first electrode lead 116 may be connected to the anode plate by welding or the like, and the connection region between the first electrode lead 116 and the anode plate may face an inner surface of the outer material 110 in the first terrace area 112 or the first terrace area 112. The connection region of the first electrode lead 116 and the anode plate may be present inside the outer material 110. Accordingly, the movement of the first electrode lead 116 may be controlled simply by pressurizing the first terrace area 112.

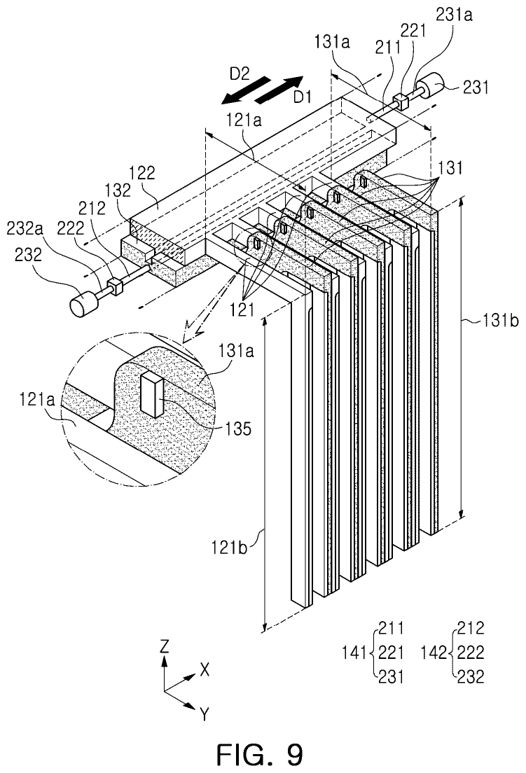

In an embodiment, the second extension portion 121b and the fourth extension portion (131b of FIG. 9) may pressurize a region corresponding to the connection region of the first electrode lead 116 and the anode plate in the outer material 110. This may be applied to the second electrode lead 117 and the second terrace area (113 of FIG. 8) using the same principle.

FIG. 8 schematically illustrates a state in which a second terrace area 113 is pressurized by another first jig arm 121 and another second jig arm 131 according to an embodiment of the present disclosure, and is illustrated from a front view.

As illustrated in FIGS. 7 and 8, in the second terrace area 113, the second electrode lead 117 and the second lead film F2 may be unpressurized by the first jig arm 121 and the second jig arm 131. The second electrode lead 117 and the second lead film F2 may not be in contact with the first jig arm 121 and the second jig arm 131.

In an embodiment, the second extension portion 121b of another first jig arm 121 and the fourth extension portion (131b of FIG. 9) of another second jig arm 131 may pressurize a region of the second terrace area 113 excluding the second lead sealing portion 115. The second lead sealing portion 115 may be a region included in the second terrace area 113.

The second lead sealing portion 115 may be formed in a direction, intersecting the side sealing portion 118. The second lead sealing portion 115 may be a region heat-welded in the outer material 110. The second lead sealing portion 115 may be disposed adjacently to the second electrode lead 117. The second lead sealing portion 115 may be formed to be parallel to the Z-axis.

The second extension portion 121b and the fourth extension portion (131b in FIG. 9) may pressurize a region between an edge of the outer material 110 in the +Y-direction and an edge of the second lead sealing portion 115 in the +Y-direction in the first terrace area 112.

In an embodiment, the second electrode lead 117 of the battery cell 10 may be in contact with the cathode plate accommodated in the electrode assembly accommodation space 111. For example, an inner surface of a region corresponding to the second terrace area 113 in the outer material 110 may face a connection region between the second electrode lead 117 and the cathode plate.

As described above, the second electrode lead 117 may also be connected to the cathode plate by welding or the like. Accordingly, the second extension portion 121b and the fourth extension portion (131b in FIG. 9) may pressurize a region corresponding to the connection region between the second electrode lead 117 and the cathode plate in the outer material 110. Accordingly, the position of the second electrode lead 117 may be aligned without contacting the second electrode lead 117 and without pressurizing the second electrode lead 117.

FIG. 9 is a partial perspective view of an apparatus for alignment of a battery cell according to another embodiment of the present disclosure. FIG. 9 illustrates a state in which a plurality of first jig arms 121 and a plurality of second jig arms 131 are moved to a position facing the battery cell 10 in order for the plurality of first jig arms 121 and the plurality of second jig arms 131 to pressurize the battery cell 10.

As illustrated in FIG. 9, in an embodiment, an alignment driver 140 may include a first alignment driver 141 connected to the first alignment body 122, and moving the first alignment body 122 in the first direction (D1, +X-direction) to bring a plurality of first jig arms 121 into contact with one surface 112a of the first terrace area 112, and a second alignment driver 142 connected to the second alignment body 132, and moving the second alignment body 132 in the second direction (D2, −X-direction) to bring a plurality of second jig arms 131 into contact with the other surface 112b of the first terrace area 112.

The first alignment driver 141 and the second alignment driver 142 may simultaneously move the first alignment body 122 and the second alignment body 132 in different directions. Accordingly, the first terrace area 112 may be prevented from being bent in one direction, and the first terrace area 112 may be aligned parallel to one surface of the outer material 110.

Additionally, in an embodiment, the first alignment driver (141 of FIG. 3) may include a first drive guide member 211 connected to the first alignment body 122, a first gear box 221 connected to the first drive guide member 211, and a first drive motor 231 in which a first drive shaft 231a is connected to the first gear box 221.

The second alignment driver (142 in FIG. 3) may include a second driving guide member 212 connected to the second alignment body 132, a second gearbox 222 connected to the second driving guide member 212, and a second driving motor 232 in which a second driving shaft 232a is connected to the second gearbox 222.

A reducer or the like may be additionally connected to the first driving shaft 231a and the second driving shaft 232a. The first gearbox 221 and the second gearbox 222 may be provided to convert rotational motions of the first driving shaft 231a and the second driving shaft 232a into linear motions of the first driving guide member 211 and the second driving guide member 212.

For example, each of the first gearbox 221 and the second gearbox 222 may be provided as combinations of a plurality of gears. For example, the plurality of gears may include racks, pinions, bevel gears, and helical gears. Accordingly, clockwise or counterclockwise rotational motions of the first drive shaft 231a and the second drive shaft 232a may be converted into linear motions of the first drive guide member 211 and the second drive guide member 212.

In an embodiment, when the first drive guide member 211 rotates clockwise, the second drive guide member 212 may rotate counterclockwise. Accordingly, the first alignment body 122 and the second alignment body 132 may move in opposite directions.

Additionally, the first drive motor 231 and the second drive motor 232 may rotate in opposite directions. Additionally, the first driving motor 231 and the second driving motor 232 may be connected to a controller and may be automatically controlled.

However, a method of moving the first alignment body 122 and the second alignment body 132 in opposite directions, whether the controller is provided, and the like, are not necessarily limited by the present disclosure.

In an embodiment, at least one of the first extension portion 121a and the third extension portion 131a may include a protruding region 135 protruding in a direction oriented toward at least one of the first extension portion 121a and the third extension portion 131a facing each other.

For example, the third extension portion 131a may be provided with a protruding region 135 protruding in a direction oriented toward the first extension portion 121a facing the third extension portion 131a.

The protruding region 135 may be provided in at least one third extension portion 131a, among the plurality of third extension portions 131a. In an embodiment, the protruding region 135 may be formed in each of the plurality of third extension portions 131a spaced apart from each other with the extension first portion 121a interposed therebetween. The protruding region 135 may protrude from the third extension portion 131a in a direction oriented toward the first extension portion 121a or in a direction (X-axis direction) approaching the first extension portion 121a.

The third extension portion 131a and the protruding region 135 may be disposed to be perpendicular to each other or to intersect each other in the X-Y plane.

Accordingly, movement limit positions of the first alignment body 122 and the second alignment body 132 may be set. The protruding region 135 may serve as a stopper restricting movements of the first alignment body 122 and the second alignment body 132. The first alignment driver (141 of FIG. 3) and the second alignment driver (141 of FIG. 3) may stop the movements of the first alignment body 122 and the second alignment body 132 when the first extension portion 121a is in contact with the protruding region 135.

In an embodiment, in a state in which the second extension portion 121b and the fourth extension portion 131b have completely pressurized the first terrace area 112, the protruding region 135 may be in contact with the first extension portion 121a.

In an embodiment, a separate sensor may be additionally provided in the protruding region 135. According thereto, it may be possible to more easily detect whether the protrusion region 135 and the first extension portion 121a are in contact with each other. Accordingly, the reliability of an operation of the apparatus for alignment of a battery cell may be improved. However, this is not necessarily limited by the present disclosure.

Meanwhile, as illustrated in FIGS. 3, 4, and 9, in an embodiment, the first alignment driver 141 may move the first alignment body 122 in the second direction D2 to release the at least one first jig arm 121 from contact with one surface 112a of the first terrace area 112, and the second alignment driver 142 may move the second alignment body 132 in the first direction D1 to release the at least one second jig arm 131 from contact with the other surface 112b of the first terrace area 112.

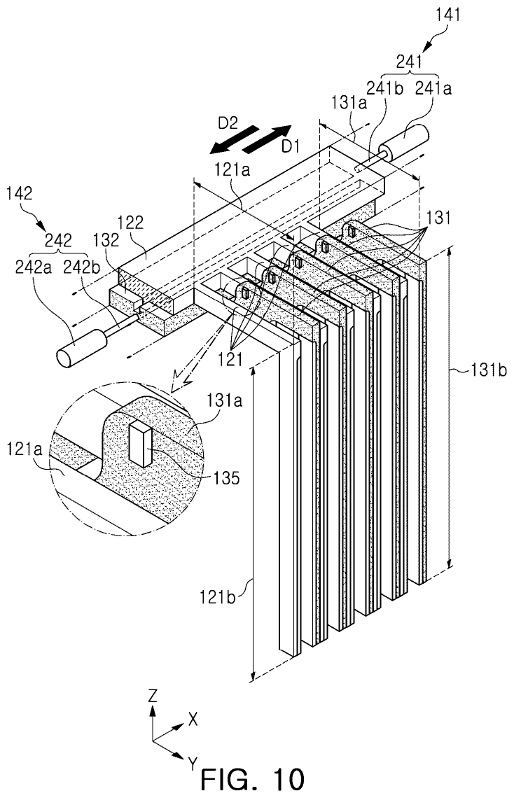

FIG. 10 is a partial perspective view of an apparatus for alignment of a battery cell according to another embodiment of the present disclosure. FIG. 10 illustrates a state in which a plurality of first jig arms 121 and a plurality of second jig arms 131 are moved to a position facing the battery cell 10 in order for the plurality of first jig arms 121 and the plurality of second jig arms 131 to pressurize the battery cell 10.

As illustrated in FIG. 10, in an embodiment, the alignment driver (140 of FIG. 3) may include a first cylinder member 241 connected to the first alignment member 120 and a second cylinder member 242 connected to the second alignment member 130.

The first cylinder member 241 may include a first cylinder body 241a and a first piston rod 241b extending or contracting in the first cylinder body 241a. The first piston rod 241b may be connected to the first alignment body 122.

The second cylinder member 242 may include a second cylinder body 242a and a second piston rod 242b extending or contracting in the second cylinder body 242a. The second piston rod 242b may be connected to the second alignment body 132.

When the first piston rod 241b moves in the +X-direction, the second piston rod 242b may move in the −X-direction, and in this case, the first terrace area 112 may be pressurized by the first jig arm 121 and the second jig arm 131, and may be in contact with the first jig arm 121 and the second jig arm 131.

When the first piston rod 241b moves in the −X-direction, the second piston rod 242b may move in the +X-direction, and in this case, the first terrace area 112 may be depressurized by the first jig arm 121 and the second jig arm 131, and may not be in contact with the first jig arm 121 and the second jig arm 131.

The first cylinder member 241 and the second cylinder member 242 may operate by hydraulic pressure or pneumatic pressure, and the type and number thereof are not necessarily limited by the present disclosure. According thereto, the linear motions of the first cylinder member 241 and the second cylinder member 242 may be directly transmitted to the first alignment body 122 and the second alignment body 132, and gears or the like, which change a direction of motion may be unnecessary.

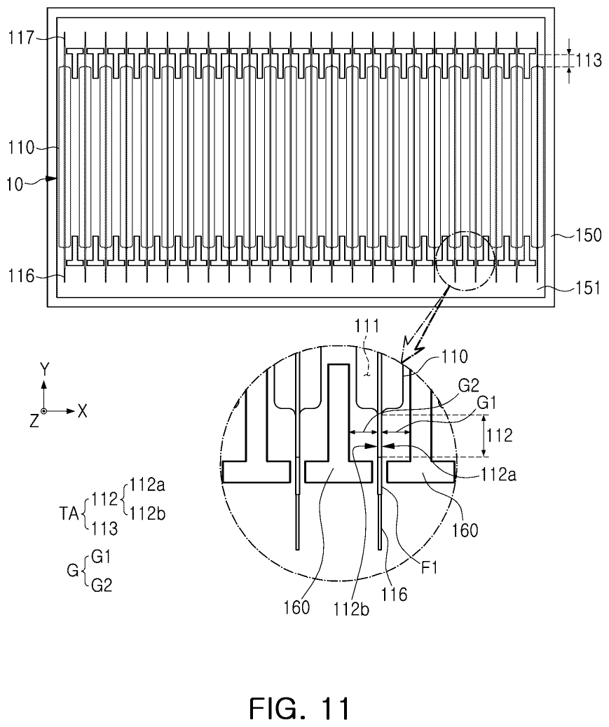

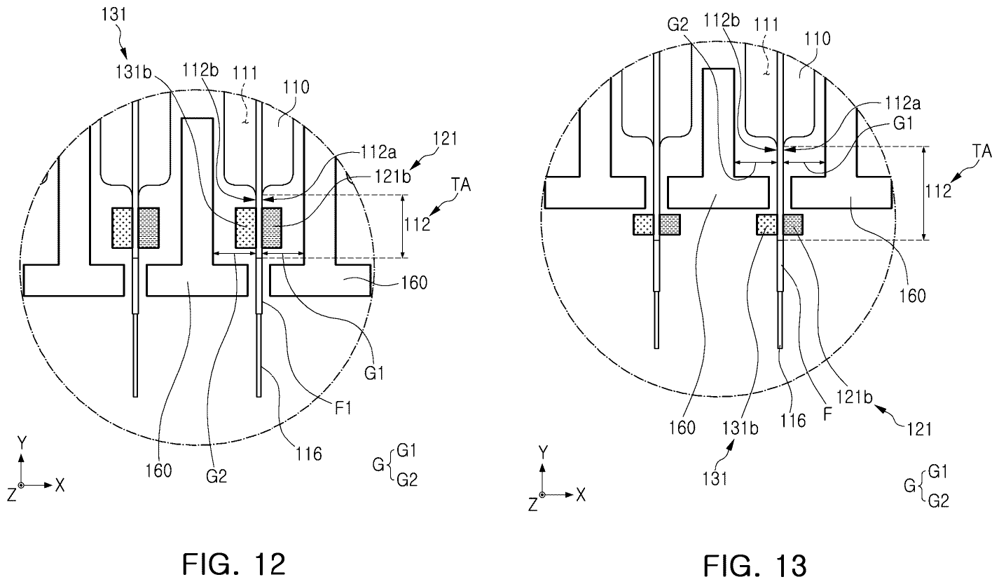

FIG. 11 is a schematic diagram of a portion of an apparatus for alignment of a battery cell according to another embodiment of the t present disclosure, and is illustrated from a plan viewpoint. FIG. 12 is a schematic diagram of a state in which a first terrace area 112 is pressurized by a first jig arm 121 and a second jig arm 131. In FIG. 12, the first extension portion (121a of FIG. 10) and the third extension portion (131a of FIG. 10) are omitted.

First, as illustrated in FIG. 11, the apparatus for alignment of a battery cell according to another embodiment of the present disclosure may further include a tray 150 supporting a plurality of battery cells 10 so that the plurality of battery cells 10 are spaced apart from each other by a predetermined gap, and a plurality of terrace alignment members 160 disposed on the tray 150 so as to be interposed between the terrace areas TA, and spaced apart from the terrace area TA by a predetermined distance to form a gap G. The gap G may also be formed between the second terrace area 113 and the terrace alignment member 160 facing the second terrace area 113.

Meanwhile, the alignment driver (140 of FIG. 3) may move the at least one first jig arm 121 and the at least one second jig arm 131 from the outside of the battery cell 10 to the gap G.

In an embodiment, the at least one first jig arm 121 may include a plurality of first jig arms 121, and the at least one second jig arm 131 may include a plurality of second jig arms 131.

Additionally, the gap G may include a first gap G1 formed between one surface 112a of the first terrace area 112 and the terrace alignment member 160, and a second gap G2 formed between the other surface 112b of the first terrace area 112 and another terrace alignment member 160. The first gap G1 may be a space surrounded by one surface 112a of the first terrace area 112 and an outer line of the terrace alignment member 160.

Additionally, the second gap G2 may be a space surrounded by the other surface 112b of the first terrace area 112a and an outer line of the other terrace alignment member 160.

The tray 150 may include an alignment space 151, and the plurality of battery cells 10 may be accommodated in the alignment space 151. In the alignment space 151, the plurality of battery cells 10 may be supported in a state of being spaced apart from each other by a predetermined gap. To this end, the tray 150 may further include a separate support member capable of spacing the plurality of battery cells 10 apart by a predetermined interval or a support groove into which a bottom surface of the battery cell 10 may be inserted, but a method of supporting the battery cell 10 of the tray 150 is not necessarily limited by the present disclosure.

The terrace alignment member 160 may be connected to the tray 150 or may be inserted into the tray 150 as a separate structure. In an embodiment, the terrace alignment member 160 may be interposed between a plurality of first terrace areas 112 and a plurality of second terrace areas 113.

The terrace alignment member 160 may face the first terrace area 112 and the second terrace area 113, but may not be in contact with the first terrace area 112 and the second terrace area 113. The terrace alignment member 160 may be spaced apart from the first terrace area 112 and the second terrace area 113 by a certain distance, thereby forming the gap G from the first terrace area 112 and the second terrace area 113.

The terrace alignment member 160 may extend to have a certain length in the Z-axis direction. The terrace alignment member 160 may be formed of a material including a resin, and may be injection molded. However, this is not necessarily limited by the present disclosure.

The terrace alignment member 160 illustrated in FIG. 11 may also be arranged in the second electrode lead 117 and the second terrace area 113, and the above-described matters may be applied to the terrace alignment member 160 disposed in the second electrode lead 117 and the second terrace area 113 using the same principle.

As illustrated in FIGS. 11 and 12, the alignment driver (140 of FIG. 3) may move the plurality of first jig arms 121 and the plurality of second jig arms 131 to the gap G. The alignment driver (140 of FIG. 3) may move the plurality of first jig arms 121 and the plurality of second jig arms 131 to the gap G without bringing the plurality of first jig arms 121 and the plurality of second jig arms 131 into contact with the first electrode lead 116. This may be applied to the second terrace area 113 and the second electrode lead 117 using the same principle.

The plurality of first jig arms 121 and the plurality of second jig arms 131 are inserted into the gap G, and may then be moved in a direction approaching the first terrace area 112. Accordingly, the first jig arm 121 and the second jig arm 131 may be in contact with one surface 112a of the first terrace area 112 and the other surface 112b of the first terrace area 112. The first jig arm 121 and the second jig arm 131 may align the position of the first electrode lead 116 by pressurizing the first terrace area 112.

When the alignment of the position of the first electrode lead 116 is completed, the first jig arm 121 and the second jig arm 131 may be moved in a direction away from one surface 112a of the first terrace area 112 and the other surface 112b of the first terrace area 112 to release the pressure applied onto the first terrace area 112. In this case, the first jig arm 121 and the second jig arm 131 may be moved in a direction away from one surface 112a of the first terrace area 112 and the other surface 112b of the first terrace area 112 in a state of being inserted into the gap G.

FIG. 13 is a plan view schematically illustrating a state in which a first terrace area 112 is pressurized by a first jig arm 121 and a second jig arm 131 according to another embodiment of the present disclosure. In FIG. 13, the first extension portion (121a of FIG. 10) and the third extension portion (131a of FIG. 10) are omitted.

As illustrated in FIG. 13, the second extension portion 121b of the first jig arm 121 and the fourth extension portion 131b of the second jig arm 131 may be spaced further apart in the −Y-direction from the electrode assembly accommodation space 111 than the terrace alignment member 160.

For example, the second extension portion 121b and the fourth extension portion 131b may pressurize the terrace area TA from the outside of the terrace alignment member 160. That is, in another embodiment of the present disclosure, the second extension portion 121b and the fourth extension portion 131b may pressurize the terrace area TA from the outside of the gap G.

As described above, the gap G may be formed between the terrace area TA and the terrace alignment member 160, and the gap G may be a separation distance in the X-axis direction between the terrace area TA and the terrace alignment member 160.

In another embodiment of the present disclosure, the second extension portion 121b of the first jig arm 121 and the second jig arm 131 may pressurize the terrace area TA from the exterior or the outside of the gap G. Accordingly, the first jig arm 121 and the second jig arm 131 may move more easily without interfering with the terrace alignment member 160.

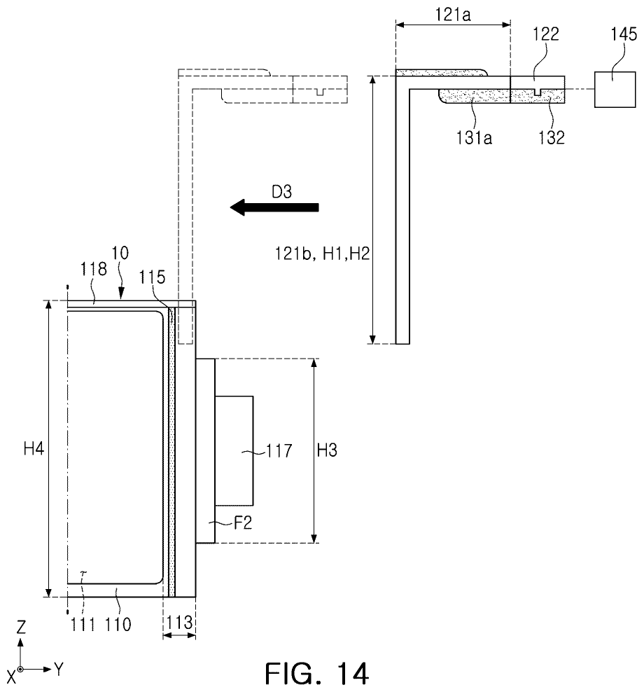

FIG. 14 schematically illustrates a state in which a driving member 145 of an apparatus for alignment of a battery cell according to another embodiment of the present disclosure moves a first jig arm 121 and a second jig arm 131, and is illustrated from a front view perspective. FIG. 14 illustrates a second terrace area 113, but the technical concept of FIG. 14 may be applied to a first terrace area 112 using the same principle.

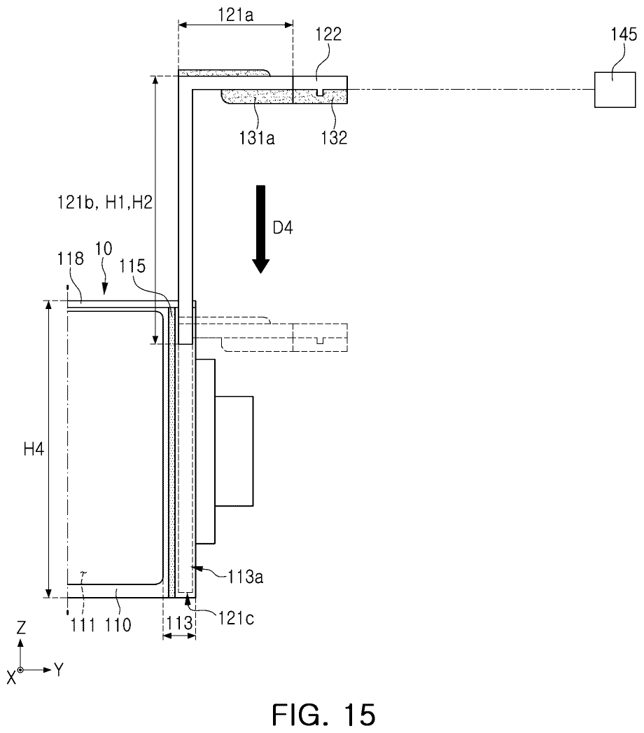

Meanwhile, FIG. 15 schematically illustrates a state in which the driving member 145 of an apparatus for alignment of a battery cell according to another embodiment of the present disclosure moves the first jig arm 121 and the second jig arm 131, and is illustrated from a front view perspective. FIG. 15 illustrates a second terrace area 113, but the technical idea of FIG. 15 may be applied to a first terrace area 112 using the same principle.

As illustrated in FIGS. 12 to 15, the alignment driver may further include a driving member 145 connected to the first jig arm 121 and the second jig arm 131. The driving member 145 may move the first jig arm 121 and the second jig arm 131 in an insertion direction D4 after the first jig arm 121 and the second jig arm 131 have completed moving in an entry direction D3.

The driving member 145 may include, for example, a robot arm and a CAM, but the type thereof is not necessarily limited by the present disclosure.

The entry direction D3 may be a direction parallel to the Y-axis, and the insertion direction D4 may be a direction intersecting or perpendicular to the entry direction D3 and a direction parallel to the Z-axis at the same time.

First, the first jig arm 121 and the second jig arm 131 may be moved in the entry direction D3 in a state of being disposed in an outer region of the battery cell 10. The first jig arm 121 and the second jig arm 131 having completed moving in the entry direction D3 may be disposed in an upper portion of the battery cell 10 in the +Z-direction.

Then, the first jig arm 121 and the second jig arm 131 may be moved in the insertion direction D4 and then moved downwardly in the −Z-direction. The first jig arm 121 and the second jig arm 131 having completed moving in the insertion direction D4 may be disposed in the gap G of the battery cell 10. Additionally, an end 121c of the first jig arm 121 having completed moving in the insertion direction D4 may face the second terrace area 113.

For example, the driving member 145 may lower the first jig arm 121 and the second jig arm 131 in a direction, parallel to the second extension portion 121b and the fourth extension portion (131b in FIG. 5). Accordingly, the first jig arm 121 and the second jig arm 131 may be moved without interfering with the battery cell 10 and the terrace alignment member (160 in FIG. 11). Accordingly, the quality of the battery cell 10 may be prevented from being deteriorated.

In an embodiment, the driving member 145 may move the at least one first jig arm 121 and the at least one second jig arm 131 in the insertion direction D4 which is a height direction of the battery cell 10, and may thus move the at least one first jig arm 121 and the at least one second jig arm 131 to the gap G.

The insertion direction D4 may be a direction intersecting or perpendicular to the entry direction. The driving member 145 may face the second extension portion 121b and the fourth extension portion (131b in FIG. 5) to the second terrace area 113. In this case, the first extension portion 121a and the third extension portion (131a in FIG. 5) may not be inserted into the gap G and may not face the second terrace area 113.

Accordingly, a position of the second electrode lead 117 may be aligned without interfering with the second electrode lead 117 and the electrode assembly accommodation space 111, and may evenly align a gap in the X-axis direction between the plurality of battery cells 10.

In an embodiment, the driving member 145 may be connected to the first jig arm 121 and the second jig arm 131, and may move the first jig arm 121 and the second jig arm 131 in the entry direction D3 and the insertion direction D4.

Additionally, in an embodiment, a height H1 of the second extension portion 121b and a height H2 of the fourth extension portion (131b in FIG. 5) may be equal to or greater than a height H3 of the second electrode lead 117 and equal to or less than a height H4 of the battery cell 10. This may be equally applied to the first electrode lead 116. According thereto, the first jig arm 121 and the second jig arm 131 may pressurize the first terrace area 112 and the second terrace area 113 without interfering with the tray 150 and the terrace alignment member 160.

Additionally, the first jig arm 121 and the second jig arm 131 may secure a maximum contact area with the first terrace area 112 and the second terrace area 113 within a range in which the first jig arm 121 and the second jig arm 131 do not interfere with the tray 150 and the terrace alignment member 160.

Additionally, in an embodiment, the height H1 of the second extension portion 121b in the Z-axis direction and the height H2 of the fourth extension portion 131b in the Z-axis direction may be less than or equal to the height H4 of the battery cell 10 in the Z-axis direction. Additionally, the second extension portion 121b and the fourth extension portion (131b in FIG. 5) may not face the side sealing portion 118 in a state of being inserted into the gap G.

Accordingly, the second terrace area 113 may be sufficiently pressurized in the height direction. Additionally, the position of the second electrode lead 117 may be aligned while avoiding contact with the side sealing portion 118 and the second electrode lead 117.

Additionally, in an embodiment, after moving the at least one first jig arm 121 and the at least one second jig arm 131 in the insertion direction D4, the driving member 145 may bring the first jig arm 121 and the second jig arm 131 into contact with one surface (113a in FIG. 13) of the second terrace area 113 and the other surface of the second terrace area 113. This may be applied to the first terrace area (112 in FIG. 11) using the same principle.

Additionally, in a state in which the first jig arm 121 and the second jig arm 131 are inserted into the gap G, a maximum width of a path through which the first alignment driver (141 in FIG. 3) and the second alignment driver (142 in FIG. 3) move the first alignment body (122 in FIG. 3) and the second alignment body (132 in FIG. 3) in the X-axis direction may be less than a width of the gap G in the X-axis direction. Accordingly, the battery cell 10 may be aligned while avoiding interfering with the terrace alignment member 160.

As described above, the outer material 110 of the battery cell 10 may be prevented from being deformed, damaged, or the like, and the battery cell 10 may be aligned while preventing the deformation, the damage or the like, of the first electrode lead 116 and the second electrode lead 117. Additionally, interference between components included in the apparatus for alignment of a battery cell may be prevented.

The contents described above are merely examples of applying the principles of the present disclosure, and other components may be further included or substituted and applied without departing from the scope of the present disclosure.

What is claimed is:

1. An apparatus for alignment of a battery cell, comprising: in order to align at least one battery cell in which an electrode assembly is accommodated inside an outer material, the outer material includes a terrace area, and at least one electrode lead is exposed to an edge of the terrace area,
a first alignment portion including at least one first jig arm facing one surface of the terrace area;
a second alignment portion including at least one second jig arm facing the other surface of the terrace area; and
an alignment driver moving the first alignment portion and the second alignment portion in different directions to bring the first jig arm and the second jig arm into contact with the one surface and the other surface.

2. The apparatus for alignment of a battery cell of claim 1, wherein the first alignment portion further includes:
a first alignment body extending by a predetermined length,
the at least one first jig arm extends from the first alignment body and faces the one surface, and
the second alignment portion further includes:
a second alignment body disposed so that at least a partial region thereof overlaps the first alignment body,
the at least one second jig arm extends from the second alignment body and faces the other surface, and
wherein the alignment driver moves the first alignment body and the second alignment body in different directions.

3. The apparatus for alignment of a battery cell of claim 2, wherein the alignment driver includes:
a first alignment driver connected to the first alignment body, and moving the first alignment body in a first direction to bring the at least one first jig arm into contact with the one surface; and
a second alignment driver connected to the second alignment body, and moving the second alignment body in a second direction to bring the at least one second jig arm into contact with the other surface.

4. The apparatus for alignment of a battery cell of claim 3, wherein the first alignment driver moves the first alignment body in the second direction to release the at least one first jig arm from contact with the one surface, and
the second alignment driver moves the second alignment body in the first direction to release the at least one second jig arm from contact with the other surface.

5. The apparatus for alignment of a battery cell of claim 3, wherein the first alignment driver and the second alignment driver simultaneously move the first alignment body and the second alignment body.

6. The apparatus for alignment of a battery cell of claim 2, wherein the at least one first jig arm includes:
a first extension portion extending in a longitudinal direction of the battery cell from the first alignment body; and
a second extension portion bent from the first extension portion and extending in a height direction of the battery cell, and contacting the one surface, and
the at least one second jig arm includes:
a third extension portion extending in the longitudinal direction of the battery cell from the second alignment body; and
a fourth extension portion bent from the third extension portion and extending in the height direction of the battery cell, and contacting the other surface.

7. The apparatus for alignment of a battery cell of claim 6, wherein the at least one first jig arm and the at least one second jig arm are not in contact with the at least one electrode lead.

8. The apparatus for alignment of a battery cell of claim 6, wherein a height of the second extension portion and a height of the fourth extension portion are greater than or equal to a height of the electrode lead and less than or equal to a height of the battery cell.

9. The apparatus for alignment of a battery cell of claim 2, wherein the first alignment body includes:
a coupling protrusion protruding in a direction oriented toward the second alignment body, and
the second alignment body includes:
a coupling notch into which the coupling protrusion is inserted.

10. The apparatus for alignment of a battery cell of claim 3, wherein the first alignment driver includes:
a first driving guide member connected to the first alignment body;
a first gear box connected to the first driving guide member; and
a first driving motor in which a first driving shaft is connected to the first gear box, and
the second alignment driver includes:
a second driving guide member connected to the second alignment body;
a second gear box connected to the second driving guide member; and
a second drive motor in which a second drive shaft is connected to the second gearbox.

11. The apparatus for alignment of a battery cell of claim 3, wherein the alignment driver includes:
a first cylinder member connected to the first alignment body; and
a second cylinder member connected to the second alignment body.

12. The apparatus for alignment of a battery cell of claim 1, wherein the at least one first jig arm includes:
a first insulating member in contact with the one surface, and
the at least one second jig arm includes:
a second insulating member in contact with the other surface.

13. The apparatus for alignment of a battery cell of claim 6, wherein the first extension portion and the third extension portion face each other, and
at least one of the first extension portion and the third extension portion includes a protruding region protruding in a direction oriented toward at least one of the first extension portion and the third extension portion facing each other.

14. The apparatus for alignment of a battery cell of claim 1, further comprising:
a tray supporting a plurality of battery cells so that the plurality of battery cells are spaced apart from each other by a predetermined distance; and
a plurality of terrace alignment members disposed on the tray so as to be interposed between the terrace areas and spaced apart from each other by a predetermined distance from the terrace areas to form a gap, and
the alignment driver further includes:
a driving member moving the at least one first jig arm and the at least one second jig arm from the outside of the plurality of battery cells to the gap.

15. The apparatus for alignment of a battery cell of claim 14, wherein the driving member moves the at least one first jig arm and the at least one second jig arm in an insertion direction, which is a height direction of the battery cell, and moves the at least one first jig arm and the at least one second jig arm into the gap.

16. The apparatus for alignment of a battery cell of claim 15, wherein the alignment driver brings the first jig arm and the second jig arm into contact with the one surface and the other surface after the at least one first jig arm and the at least one second jig arm are moved in the insertion direction.
